(19) United States
(12) Patent Application Publication
(10) Pub. No.: US 2019/0011981 A1
(43) Pub. Date: Jan. 10, 2019

(54) INFORMATION PROCESSING METHOD, SYSTEM FOR EXECUTING THE INFORMATION PROCESSING METHOD, AND INFORMATION PROCESSING SYSTEM

(71) Applicant: COLOPL, Inc., Tokyo (JP)

(72) Inventor: Yasuhiro NOGUCHI, Tokyo (JP)

(21) Appl. No.: 15/753,958

(22) PCT Filed: Mar. 10, 2017
(86) PCT No.: PCT/JP2017/009739

§ 371 Date: Feb. 20, 2018

(30) Foreign Application Priority Data
Sep. 8, 2016 (JP) 2016-175916

(51) Int. Cl. G06F 3/01; G06F 3/0482; G06T 19/00

(52) U.S. Cl. CPC G06F 3/012; G06T 19/006; G06F 3/014; G06F 3/0482

(57) ABSTRACT

An information processing method includes generating virtual space data for defining a virtual space. The virtual space includes a first object for displaying a menu; a second object capable of operating the menu; and an operation object. The method further includes detecting a movement of a head-mounted device and a movement of a part of a body other than a head of a user. The method further includes displaying a visual-field image based on the virtual space data corresponding to the detected movement of the head-mounted device on a display unit of the head-mounted device. The method further includes causing the operation object to act in accordance with the detected movement of the part of the body of the user. The method further includes operating the menu based on an input operation performed on the second object by the operation object.

### RELATED APPLICATIONS

The present application is a National Stage of PCT International Application No. PCT/JP2017/009739, filed Mar. 10, 2017, which claims priority to Japanese Patent Application No. 2016-175916 filed Sep. 8, 2016.

### TECHNICAL FIELD

This disclosure relates to an information processing method, a system for executing the information processing method, and an information processing system.

### BACKGROUND

There is known a technology for arranging a user interface (UI) object within a virtual space. For example, in the disclosure of PTL 1, a widget (example of the UI object) is arranged within the virtual space, and the widget is displayed within a visual field of a virtual camera. When the widget is positioned outside the visual field of the virtual camera as a result of a movement of a head-mounted device (HMD), the widget is moved so as to be positioned within the visual field of the virtual camera. In this manner, while the widget is arranged within the virtual space, the widget is constantly displayed within a visual-field image displayed on the HMD.

### CITATION LIST

### Patent Literature

[PTL 1] JP 5876607 B2

### SUMMARY

Incidentally, when a widget is constantly displayed within a visual-field image as described in PTL 1, a user may feel annoyed at the widget. In particular, while the widget is displayed in the visual-field image, the user cannot sufficiently feel a sense of immersion into a virtual space.

At least one embodiment of this disclosure has an object to provide an information processing method and a system for achieving the information processing method, which are capable of further enhancing a sense of immersion into a virtual space to be felt by a user.

According to at least one embodiment of this disclosure, there is provided an information processing method, which is executed by a processor of a computer configured to control a head-mounted device including a display unit.

The information processing method includes generating virtual space data for defining a virtual space. The virtual space includes a virtual camera; a first object, which is fixedly arranged within the virtual space, and is configured to display a menu; a second object capable of operating the menu displayed on the first object; and an operation object. The method further includes acquiring a detection result from a detection unit configured to detect a movement of the head-mounted device and a movement of a part of a body other than a head of a user. The method further includes updating a visual field of the virtual camera in accordance with the movement of the head-mounted device. The method further includes generating visual-field image data based on the visual field of the virtual camera and the virtual space data. The method further includes displaying a visual-field image on the display unit based on the visual-field image data. The method further includes causing the operation object to act in accordance with the movement of the part of the body of the user. The method further includes operating the menu displayed on the first object based on an input operation performed on the second object by the operation object.

According to at least one embodiment of this disclosure, it is possible to provide an information processing method and a system for achieving the information processing method, which are capable of further enhancing a sense of immersion into the virtual space to be felt by the user.

### BRIEF DESCRIPTION OF DRAWINGS

FIG. 1 is a schematic diagram of a head-mounted device (HMD) system according to at least one embodiment of this disclosure.

FIG. 2 is a diagram of a head of a user wearing an HMD according to at least one embodiment of this disclosure.

FIG. 3 is a diagram of a hardware configuration of a control device according to at least one embodiment of this disclosure.

FIG. 4 is a diagram of an example of a specific configuration of an external controller according to at least one embodiment of this disclosure.

FIG. 5 is a flowchart of processing of displaying a visual-field image on the HMD according to at least one embodiment of this disclosure.

FIG. 6 is an xyz spatial diagram of an example of a virtual space according to at least one embodiment of this disclosure.

FIG. 7A is a diagram of a yx plane diagram of the virtual space in FIG. 6 according to at least one embodiment of this disclosure.

FIG. 7B is a diagram of a zx plane diagram of the virtual space in FIG. 6 according to at least one embodiment of this disclosure.

FIG. 8 is a diagram of an example of the visual-field image displayed on the HMD according to at least one embodiment of this disclosure.

FIG. 9 is a diagram of the virtual space including a virtual camera, a hand object, a tablet object, and a monitor object according to at least one embodiment of this disclosure.

FIG. 10 is a diagram of an example of a display screen of the tablet object according to at least one embodiment of this disclosure.

FIG. 11 is a flowchart of an information processing method according to at least one embodiment of this disclosure.

FIG. 12 is a flowchart of an example of a method for setting a moving range of the tablet object according to at least one embodiment of this disclosure.

FIG. 13A is a diagram of a user is immersed in the virtual space according to at least one embodiment of this disclosure.

FIG. 13B is a diagram of an example of the moving range of the tablet object set around the virtual camera according to at least one embodiment of this disclosure.

FIG. 13C is a diagram of an example of the moving range of the tablet object set around the virtual camera according to at least one embodiment of this disclosure.

FIG. 14A is a diagram of a tablet object is positioned outside the moving range according to at least one embodiment of this disclosure.

FIG. 14B is a diagram of the tablet object moving from outside the moving range to a predetermined position within the moving range according to at least one embodiment of this disclosure.

### DETAILED DESCRIPTION

A description is given of an outline of at least one embodiment of this disclosure.

(1) An information processing method, which is executed by a processor of a computer configured to control a head-mounted device including a display unit. The information processing method includes generating virtual space data for defining a virtual space. The virtual space includes a virtual camera; a first object, which is fixedly arranged within the virtual space, and is configured to display a menu; a second object capable of operating the menu displayed on the first object; and an operation object. The method further includes acquiring a detection result from a detection unit configured to detect a movement of the head-mounted device and a movement of a part of a body other than a head of a user. The method further includes updating a visual field of the virtual camera in accordance with the movement of the head-mounted device. The method further includes generating visual-field image data based on the visual field of the virtual camera and the virtual space data. The method further includes displaying a visual-field image on the display unit based on the visual-field image data. The method further includes causing the operation object to act in accordance with the movement of the part of the body of the user. The method further includes operating the menu displayed on the first object based on an input operation performed on the second object by the operation object.

The input operation may be identified based on an interaction between the second object and the operation object. Further, the virtual space data may further include an agent object to be operated based on an action of the operation object, and the input operation may be identified based on an interaction between the second object and the agent object.

According to the method described above, the menu displayed on the first object is operated based on the input operation performed on the second object by the operation object. That is, the user can perform a predetermined operation on the second object within the virtual space through use of the operation object within the virtual space, which is synchronized with the movement of the part (for example, a hand) of the body of the user. As a result of the predetermined operation, the menu displayed on the first object is operated. In this manner, the menu operation can be executed by an interaction between the objects within the virtual space. In addition, the first object and the second object are not constantly displayed within a visual-field image, and hence a situation in which a widget or other such UI object may be constantly displayed within the visual-field image is avoided. Therefore, an information processing method capable of further enhancing a sense of immersion into the virtual space to be felt by the user is provided.

(2) An information processing method according to Item (1), further including setting a moving range of the second object based on a position of the virtual camera. The method further includes determining whether or not the second object is positioned within the moving range. The method further includes moving, in response to a determination that the second object is not positioned within the moving range, the second object to a predetermined position within the moving range.

According to the method described above, in response to a determination that the second object is not positioned within the moving range of the second object, the second object moves to the predetermined position within the moving range. For example, the second object is arranged outside the moving range after the user moves without holding the second object or after the user throws away the second object. Even when the second object is positioned outside the moving range in such a situation, the second object moves to the predetermined position within the moving range. In this manner, the user is allowed to easily find the second object, and to greatly alleviate time and labor for the user to pick up the second object.

(3) An information processing method according to Item (2), in which the moving of the second object includes moving the second object to the predetermined position within the moving range based on the position of the virtual camera and a position of the first object.

According to the method described above, the second object is moved to the predetermined position within the moving range based on the position of the virtual camera and the position of the first object. In this manner, the position of the second object is determined based on a positional relationship between the first object and the virtual camera, which allows the user to easily find the second object.

(4) An information processing method according to Item (2) or (3), in which the setting of the moving range includes measuring a distance between the head of the user and the part of the body of the user. The setting of the moving range further includes setting the moving range based on the measured distance and the position of the virtual camera.

According to the method described above, the moving range of the second object is set based on the distance between the head of the user and the part of the body of the user (for example, a hand) and the position of the virtual camera. In this manner, the second object is arranged within a range that allows the user to pick up the second object while standing still, which can greatly alleviate the time and labor for the user to pick up the second object.

(5) An information processing method according to Item (2) or (3), in which the setting of the moving range includes identifying a maximum value of the distance between the head of the user and the part of the body of the user based on a position of the head of the user and a position of the part of the body of the user. The setting of the moving range further includes setting the moving range based on the identified maximum value of the distance and the position of the virtual camera.

According to the method described above, the moving range of the second object is set based on the maximum value of the distance between the head of the user and the part of the body of the user and the position of the virtual camera. In this manner, the second object is arranged within a range that allows the user to pick up the second object while standing still, which can greatly alleviate the time and labor for the user to pick up the second object.

(6) An information processing method according to Item (2) or (3), in which the setting of the moving range includes identifying a maximum value of a distance between the virtual camera and the operation object based on the position of the virtual camera and a position of the operation object. The setting of the moving range further includes setting the moving range based on the identified maximum value of the distance and the position of the virtual camera.

According to the method described above, the moving range of the second object is set based on the maximum value of the distance between the virtual camera and the operation object and the position of the virtual camera. In this manner, the second object is arranged within a range that allows the user to pick up the second object while standing still, which can greatly alleviate the time and labor for the user to pick up the second object.

(7) A system for executing the information processing method of any one of Items (1) to (5). An information processing device, including at least: a processor; and a memory, in which the processor is configured to control the information processing device to execute the information processing method of any one of Items (1) to (5). An information processing system, including an information processing device, the information processing device including at least: a processor; and a memory, in which the information processing system is configured to execute the information processing method of any one of Items (1) to (5).

According to the method described above, a system, an information processing device, and an information processing system, are provided which are capable of further enhancing a sense of immersion into the virtual space to be felt by the user.

Now, at least one embodiment provided by this disclosure is described below with reference to the drawings. Once a component is described in this description of the embodiment, a description on a component having the same reference number as that of the already described component is omitted for the sake of convenience.

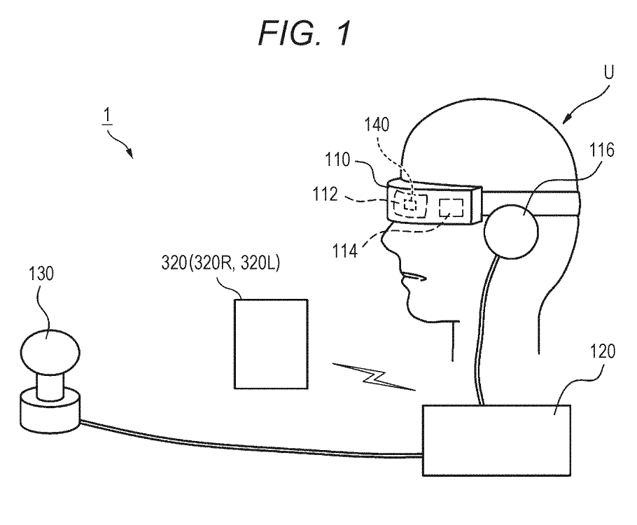

First, with reference to FIG. 1, a configuration of a head-mounted device (HMD) system 1 is described. FIG. 1 is a schematic diagram of the HMD system 1 according to at least one embodiment of this disclosure. In FIG. 1, the HMD system 1 includes an HMD 110 worn on a head of a user U, a position sensor 130, a control device 120, an external controller 320, and headphones 116.

The HMD 110 includes a display unit 112, an HMD sensor 114, and an eye gaze sensor 140. The display unit 112 includes a non-transmissive display device configured to cover a field of view (visual field) of the user U wearing the HMD 110. With this, the user U can be immersed in a virtual space by seeing only the visual-field image displayed on the display unit 112. The display unit 112 may be configured integrally with the body of the HMD 110, or may be configured separately from the body of the HMD 110. The display unit 112 may include a left-eye display unit configured to provide an image to a left eye of the user U, and a right-eye display unit configured to provide an image to a right eye of the user U. Further, the HMD 110 may include a transmissive display device. In this case, the transmissive display device may be able to be temporarily configured as the non-transmissive display device by adjusting the transmittance thereof.

The HMD sensor 114 is mounted near the display unit 112 of the HMD 110. The HMD sensor 114 includes at least one of a geomagnetic sensor, an acceleration sensor, or an inclination sensor (for example, an angular velocity sensor or a gyro sensor), and can detect various movements of the HMD 110 worn on the head of the user U.

The eye gaze sensor 140 has an eye tracking function of detecting a line-of-sight direction of the user U. For example, the eye gaze sensor 140 may include a right-eye gaze sensor and a left-eye gaze sensor. The right-eye gaze sensor may be configured to detect reflective light reflected fromthe right eye (in particular, the cornea or the iris) of the user U by irradiating the right eye with, for example, infrared light, to thereby acquire information relating to a rotational angle of a right eyeball. Meanwhile, the left-eye gaze sensor may be configured to detect reflective light reflected from the left eye (in particular, the cornea or the iris) of the user U by irradiating the left eye with, for example, infrared light, to thereby acquire information relating to a rotational angle of a left eyeball.

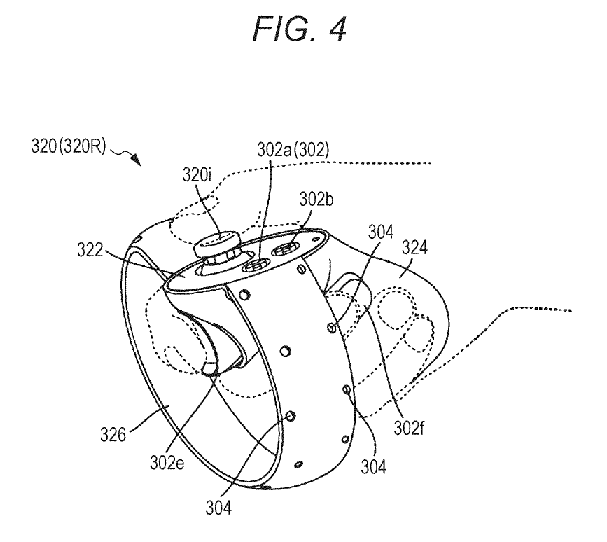

The position sensor 130 is constructed of, for example, a position tracking camera, and is configured to detect the positions of the HMD 110 and the external controller 320. The position sensor 130 is connected to the control device 120 so as to enable communication to/from the control device 120 in a wireless or wired manner. The position sensor 130 is configured to detect information relating to positions, inclinations, or light emitting intensities of a plurality of detection points (not shown) provided in the HMD 110. Further, the position sensor 130 is configured to detect information relating to positions, inclinations, and/or light emitting intensities of a plurality of detection points 304 (refer to FIG. 4) provided in the external controller 320. The detection points are, for example, light emitting portions configured to emit infrared light or visible light. Further, the position sensor 130 may include an infrared sensor or a plurality of optical cameras.

In at least one embodiment, the HMD sensor 114, the eye gaze sensor 140, the position sensor 130, and other such sensor may be collectively referred to as “detection unit”. The detection unit is configured to detect the movement of a part of the body of the user U (for example, a hand of the user U), and to transmit a signal indicating a result of the detection to the control device 120. The detection unit has a function of detecting the movement of the head of the user U (function implemented by the HMD sensor 114) and a function of detecting the movement of a part of the body other than the head of the user U (function implemented by the position sensor 130). The detection unit may also have a function of detecting a movement of a line of sight of the user U (function implemented by the eye gaze sensor 140).

The control device 120 is a computer configured to control the HMD 110. The control device 120 is capable of acquiring positional information of the HMD 110 based on the information acquired from the position sensor 130, and accurately associating a position of a virtual camera in the virtual space with the position of the user U wearing the HMD 110 in the real space based on the acquired positional information. Further, the control device 120 is capable of acquiring positional information of the external controller 320 based on the information acquired from the position sensor 130, and accurately associating a position of a hand object 400 (described later) to be displayed in the virtual space with the position of the external controller 320 in the real space based on the acquired positional information.

Further, the control device 120 is capable of identifying each of the line of sight of the right eye and the line of sight of the left eye of the user U based on the information transmitted from the eye gaze sensor 140, to thereby identify a point of gaze being an intersection between the line of sight of the right eye and the line of sight of the left eye. Further, the control device 120 is capable of identifying a line-of-sight direction of the user U based on the identified point of gaze. In this case, the line-of-sight direction of the user U is a line-of-sight direction of both eyes of the user U, and matches a direction of a straight line passing through the point of gaze and a midpoint of a line segment connecting between the right eye and the left eye of the user U.

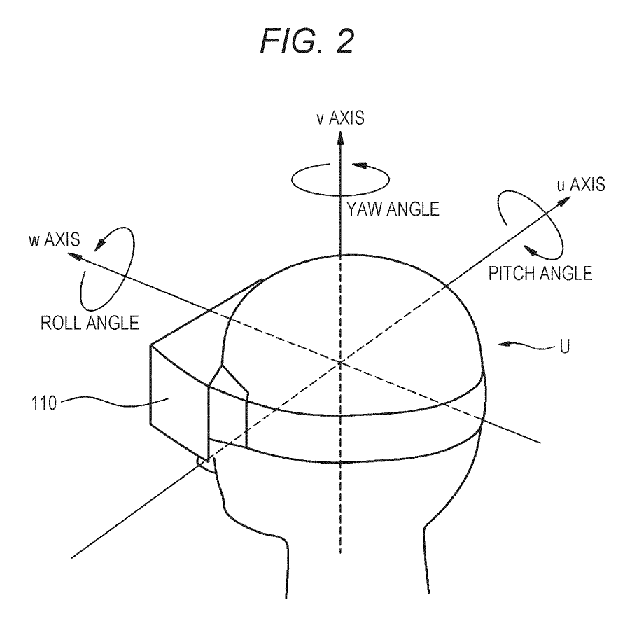

Next, with reference to FIG. 2, a method of acquiring information relating to a position and an inclination of the HMD 110 is described. FIG. 2 is a diagram of the head of the user U wearing the HMD 110 according to at least one embodiment of this disclosure. The information relating to the position and the inclination of the HMD 110, which are synchronized with the movement of the head of the user U wearing the HMD 110, can be detected by the position sensor 130 and/or the HMD sensor 114 mounted on the HMD 110. In FIG. 2, three-dimensional coordinates (uvw coordinates) are defined about the head of the user U wearing the HMD 110. A perpendicular direction in which the user U stands upright is defined as a v axis, a direction being orthogonal to the v axis and passing through the center of the HMD 110 is defined as a w axis, and a direction orthogonal to the v axis and the w axis is defined as a u axis. The position sensor 130 and/or the HMD sensor 114 are/is configured to detect angles about the respective uvw axes (that is, inclinations determined by a yaw angle representing the rotation about the v axis, a pitch angle representing the rotation about the u axis, and a roll angle representing the rotation about the w axis). The control device 120 is configured to determine angular information for controlling a visual axis of the virtual camera based on the detected change in angles about the respective uvw axes.

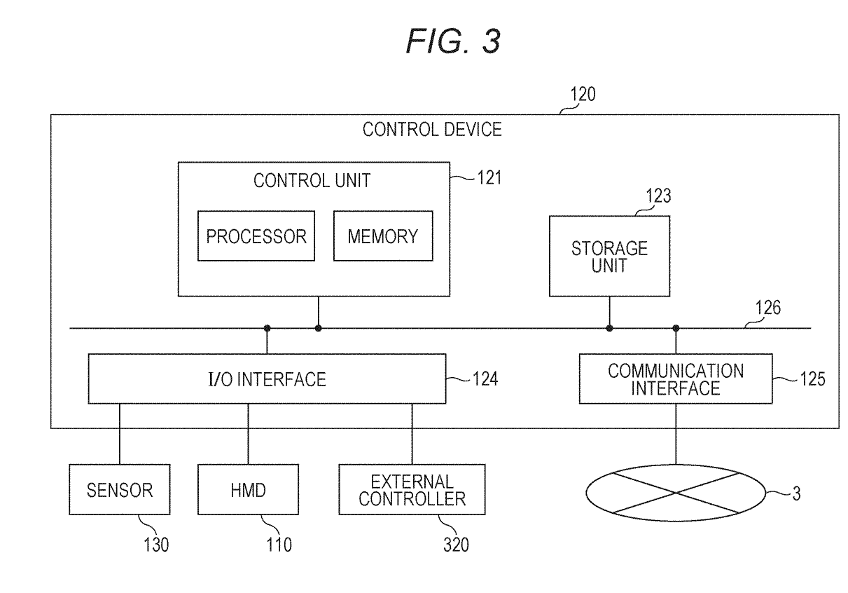

Next, with reference to FIG. 3, a hardware configuration of the control device 120 is described. FIG. 3 is a diagram of the hardware configuration of the control device 120 according to at least one embodiment of this disclosure. In FIG. 3, the control device 120 includes a control unit 121, a storage unit 123, an input/output (I/O) interface 124, a communication interface 125, and a bus 126. The control unit 121, the storage unit 123, the I/O interface 124, and the communication interface 125 are connected to each other via the bus 126 so as to enable communication therebetween.

The control device 120 maybe constructed as a personal computer, a tablet computer, or a wearable device separately from the HMD 110, or may be built into the HMD 110. Further, a part of the functions of the control device 120 may be mounted to the HMD 110, and the remaining functions of the control device 120 may be mounted to another device separate from the HMD 110.

The control unit 121 includes a memory and a processor. The memory is constructed of, for example, a read only memory (ROM) having various programs and the like stored therein or a random access memory (RAM) having a plurality of work areas in which various programs to be executed by the processor are stored. The processor is constructed of, for example, a central processing unit (CPU), a micro processing unit (MPU) and/or a graphics processing unit (GPU), and is configured to develop, on the RAM, programs designated by various programs installed into the ROM to execute various types of processing in cooperation with the RAM.

In particular, the control unit 121 may control various operations of the control device 120 by causing the processor to develop, on the RAM, a program (to be described later) for executing the information processing method on a computer according to this embodiment to execute the program in cooperation with the RAM. The control unit 121 executes a predetermined application program (game program) stored in the memory or the storage unit 123 to display a virtual space (visual-field image) on the display unit 112 of the HMD 110. With this, the user U can be immersed in the virtual space displayed on the display unit 112.

The storage unit (storage) 123 is a storage device, for example, a hard disk drive (HDD), a solid state drive (SSD), or a USB flash memory, and is configured to store programs and various types of data. The storage unit 123 may store the program for executing the information processing method on a computer according to this embodiment. Further, the storage unit 123 may store programs for authentication of the user U and game programs including data relating to various images and objects. Further, a database including tables for managing various types of data may be constructed in the storage unit 123.

The I/O interface 124 is configured to connect each of the position sensor 130, the HMD 110, and the external controller 320 to the control device 120 so as to enable communication therebetween, and is constructed of, for example, a universal serial bus (USB) terminal, a digital visual interface (DVI) terminal, or a high-definition multimedia interface (R) (HDMI) terminal. The control device 120 may be wirelessly connected to each of the position sensor 130, the HMD 110, and the external controller 320.

The communication interface 125 is configured to connect the control device 120 to a communication network 3, for example, a local area network (LAN), a wide area network (WAN), or the Internet. The communication interface 125 includes various wire connection terminals and various processing circuits for wireless connection for communication to/from an external device on a network via the communication network 3, and is configured to adapt to communication standards for communication via the communication network 3.

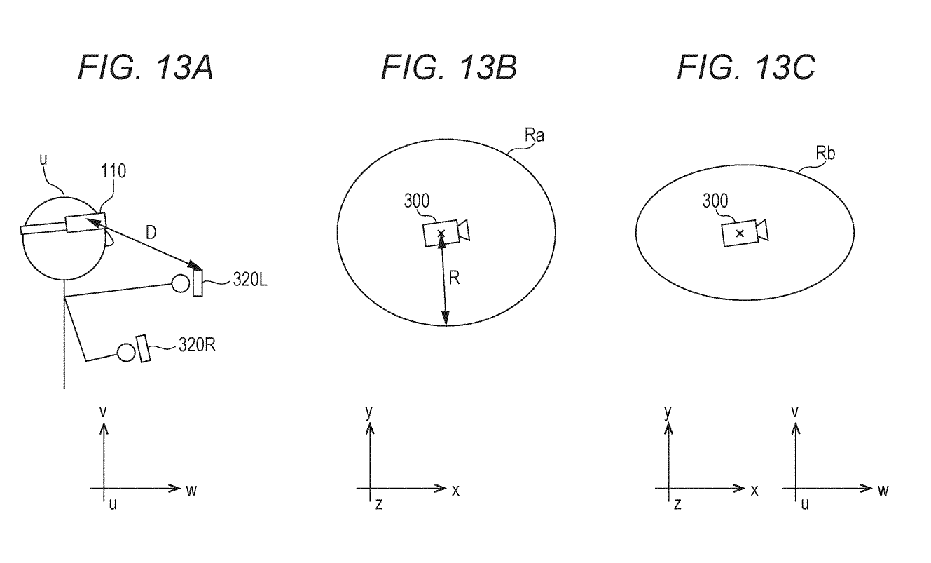

Next, an example of a specific configuration of the external controller 320 is described with reference to FIG. 4. The external controller 320 is used to control an action of a hand object displayed within the virtual space by detecting the movement of a part of the body of the user U (body part other than the head, and in this embodiment, hand of the user U). The external controller 320 includes an external controller 320R for a right hand (hereinafter referred to simply as “controller 320R”) to be operated by the right hand of the user U and an external controller 320L for a left hand (hereinafter referred to simply as “controller 320L”) to be operated by the left hand of the user U (see a state (a) of FIGS. 13). The controller 320R is a device configured to indicate a position of the right hand of the user U and movements of the right hand and its fingers. Aright hand object existing within the virtual space is moved in accordance with the movement of the controller 320R. The controller 320L is a device configured to indicate a position of the left hand of the user U and movements of the left hand and its fingers. A left hand object existing within the virtual space is moved in accordance with the movement of the controller 320L. The controller 320R and the controller 320L have substantially the same configuration, and hence only a specific configuration of the controller 320R is described below with reference to FIG. 4. In the following description, for the sake of convenience, the controllers 320L and 320R may be collectively referred to simply as “controller 320”. In addition, the right hand object synchronized with the movement of the controller 320R and the left hand object synchronized with the movement of the controller 320L may be collectively referred to simply as “hand object 400”.

In FIG. 4, the controller 320R includes an operation button 302, a plurality of detection points 304, a sensor (not shown), and a transceiver (not shown). The controller 320R may be provided with only one of the detection points 304 and the sensor. The operation button 302 is formed of a group of a plurality of buttons configured to receive an operation input from the user U. The operation button 302 includes a push button, a trigger button, and an analog stick. The push button is a button to be operated through an action of pressing the button by a thumb. For example, two push buttons 302a and 302b are provided on a top surface 322. The trigger button is a button to be operated through such an action as to pull a trigger by an index finger or a middle finger. For example, a trigger button 302e is provided to a front surface part of a grip 324, and a trigger button 302f is provided to a side surface part of the grip 324. The trigger buttons 302e and 302f are operated by the index finger and the middle finger, respectively. The analog stick is a stick-type button that can be operated by being tilted toward any direction of 360 degrees from a predetermined neutral position. For example, an analog stick 320i is provided on the top surface 322, and is operated by the thumb.

The controller 320R includes a frame 326 extending from both side surfaces of the grip 324 toward a direction opposite to the top surface 322 so as to form a semicircular ring. The plurality of detection points 304 are embedded in the frame 326 on its outside surface. The plurality of detection points 304 are, for example, a plurality of infrared LEDs arranged in a line along a circumferential direction of the frame 326. After the position sensor 130 detects information relating to the positions, the inclinations, or the light emitting intensities of the plurality of detection points 304, the control device 120 acquires information relating to the position and the posture (inclination and direction) of the controller 320R based on the information detected by the position sensor 130.

The sensor of the controller 320R may be any one of or a combination of, for example, a magnetic sensor, an angular velocity sensor, and an acceleration sensor. When the user U moves the controller 320R, the sensor outputs a signal (signal indicating information relating to, for example, magnetism, an angular velocity, or an acceleration) corresponding to the direction and the position of the controller 320R. The control device 120 acquires the information relating to the position and the posture of the controller 320R based on the signal output from the sensor.

The transceiver of the controller 320R is configured to transmit/receive data between the controller 320R and the control device 120. For example, the transceiver may transmit an operation signal corresponding to the operation input performed by the user U to the control device 120. The transceiver may also receive an instruction signal for instructing the controller 320R to emit light of the detection points 304 fromthe control device 120. In addition, the transceiver may transmit a signal indicating a value detected by the sensor to the control device 120.

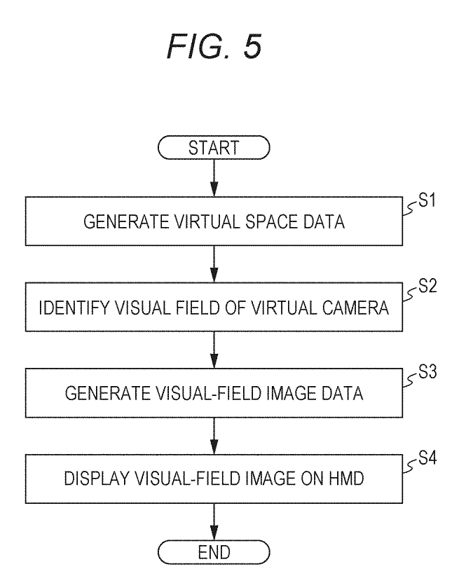

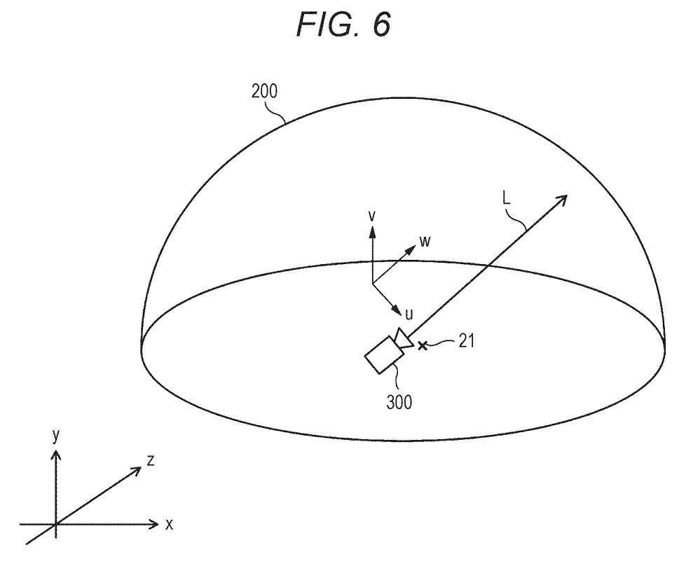

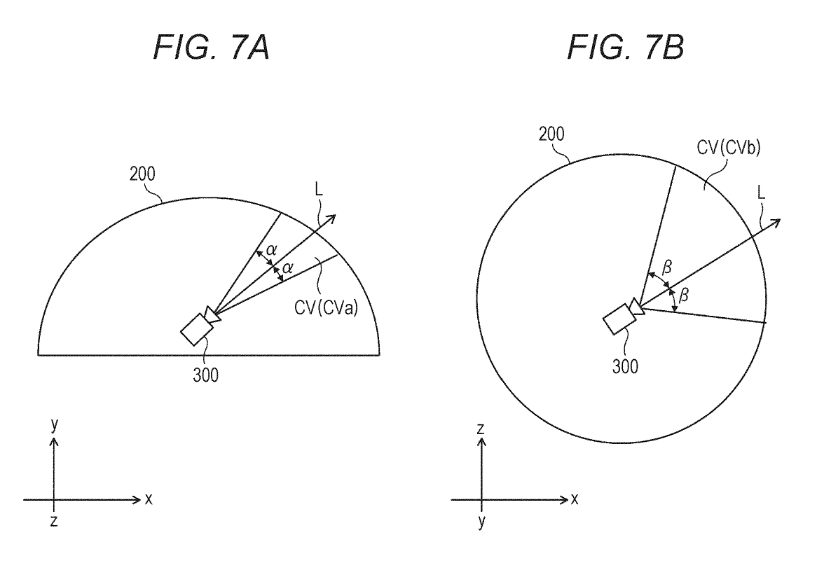

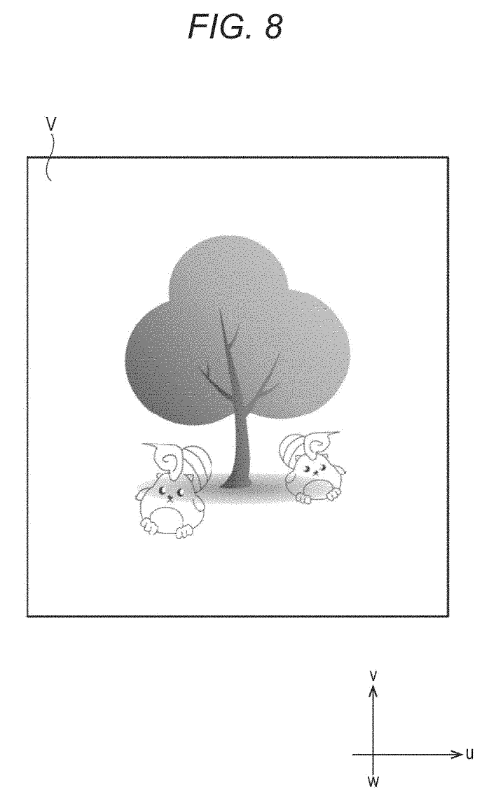

Next, with reference to FIG. 5 to FIG. 8, processing for displaying the visual-field image on the HMD 110 is described. FIG. 5 is a flowchart of the processing of displaying the visual-field image on the HMD 110 according to at least one embodiment of this disclosure. FIG. 6 is an xyz spatial diagram of an example of a virtual space 200 according to at least one embodiment of this disclosure. FIG. 7A is a yx plane diagram of the virtual space 200 in FIG. 6 according to at least one embodiment of this disclosure. FIG. 7B is a zx plane diagram of the virtual space 200 in FIG. 6 according to at least one embodiment of this disclosure. FIG. 8 is a diagram of an example of a visual-field image V displayed on the HMD 110 according to at least one embodiment of this disclosure.

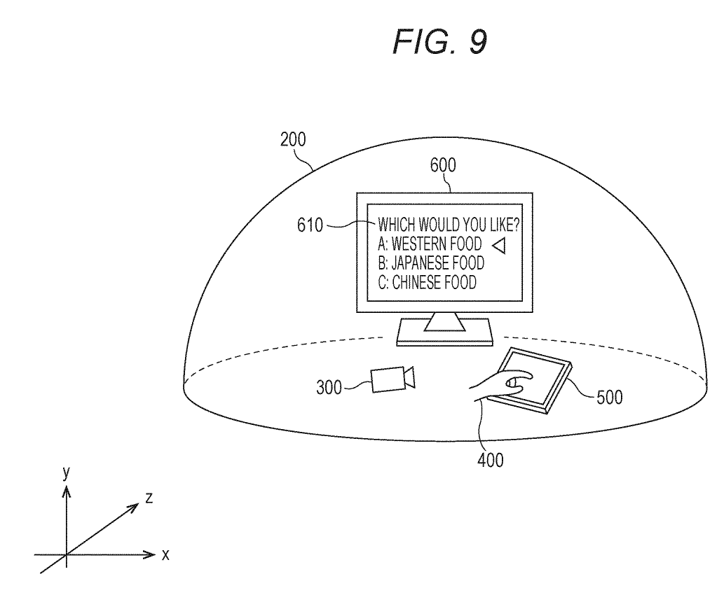

In FIG. 5, in Step S1, the control unit 121 (refer to FIG. 3) generates virtual space data representing the virtual space 200 including a virtual camera 300 and various objects. In FIG. 6, the virtual space 200 is defined as an entire celestial sphere having a center position 21 as the center (in FIG. 6, only the upper-half celestial sphere is included for the sake of clarity). Further, in the virtual space 200, an xyz coordinate system having the center position 21 as the origin is set. The virtual camera 300 defines a visual axis L for identifying the visual-field image V (refer to FIG. 8) to be displayed on the HMD 110. The uvw coordinate system that defines the visual field of the virtual camera 300 is determined so as to synchronize with the uvw coordinate system that is defined about the head of the user U in the real space. Further, the control unit 121 may move the virtual camera 300 in the virtual space 200 in synchronization with the movement in the real space of the user U wearing the HMD 110. Further, the various objects in the virtual space 200 include, for example, a tablet object 500, a monitor object 600, and a hand object 400 (refer to FIG. 9).

Next, in Step S2, the control unit 121 identifies a visual field CV (refer to FIG. 7) of the virtual camera 300. Specifically, the control unit 121 acquires data representing the state of the HMD 110, which is transmitted from the position sensor 130 and/or the HMD sensor 114, and acquires information relating to a position and an inclination of the HMD 110 based on the data. Next, the control unit 121 identifies the position and the direction of the virtual camera 300 in the virtual space 200 based on the information relating to the position and the inclination of the HMD 110. Next, the control unit 121 determines the visual axis L of the virtual camera 300 based on the position and the direction of the virtual camera 300, and identifies the visual field CV of the virtual camera 300 based on the determined visual axis L. In this case, the visual field CV of the virtual camera 300 corresponds to a part of the region of the virtual space 200 that can be visually recognized by the user U wearing the HMD 110. In other words, the visual field CV corresponds to a part of the region of the virtual space 200 to be displayed on the HMD 110. Further, the visual field CV has a first region CVa set as an angular range of a polar angle a about the visual axis L in the xy plane in FIG. 7A, and a second region CVb set as an angular range of an azimuth β about the visual axis L in the xz plane in FIG. 7B. The control unit 121 may identify the line-of-sight direction of the user U based on data representing the line-of-sight direction of the user U, which is transmitted from the eye gaze sensor 140, and may determine the direction of the virtual camera 300 based on the line-of-sight direction of the user U.

As described above, the control unit 121 can identify the visual field CV of the virtual camera 300 based on the data transmitted from the position sensor 130 and/or the HMD sensor 114. In this case, when the user U wearing the HMD 110 moves, the control unit 121 can change the visual field CV of the virtual camera 300 based on the data representing the movement of the HMD 110, which is transmitted from the position sensor 130 and/or the HMD sensor 114. That is, the control unit 121 can change the visual field CV in accordance with the movement of the HMD 110. Similarly, when the line-of-sight direction of the user U changes, the control unit 121 can move the visual field CV of the virtual camera 300 based on the data representing the line-of-sight direction of the user U, which is transmitted from the eye gaze sensor 140. That is, the control unit 121 can change the visual field CV in accordance with the change in the line-of-sight direction of the user U.

Next, in Step S3, the control unit 121 generates visual-field image data representing the visual-field image V to be displayed on the display unit 112 of the HMD 110. Specifically, the control unit 121 generates the visual-field image data based on the virtual space data defining the virtual space 200 and the visual field CV of the virtual camera 300.

Next, in Step S4, the control unit 121 displays the visual-field image V on the display unit 112 of the HMD 110 based on the visual-field image data (refer to FIGS. 7A-7B). As described above, the visual field CV of the virtual camera 300 is updated in accordance with the movement of the user U wearing the HMD 110, and thus the visual-field image V to be displayed on the display unit 112 of the HMD 110 is updated as well. Thus, the user U can be immersed in the virtual space 200.

The virtual camera 300 may include a left-eye virtual camera and a right-eye virtual camera. In this case, the control unit 121 generates left-eye visual-field image data representing a left-eye visual-field image based on the virtual space data and the visual field of the left-eye virtual camera. Further, the control unit 121 generates right-eye visual-field image data representing a right-eye visual-field image based on the virtual space data and the visual field of the right-eye virtual camera. After that, the control unit 121 displays the left-eye visual-field image and the right-eye visual-field image on the display unit 112 of the HMD 110 based on the left-eye visual-field image data and the right-eye visual-field image data. In this manner, the user U can visually recognize the visual-field image as a stereoscopic three-dimensional image from the left-eye visual-field image and the right-eye visual-field image. Herein, for the sake of convenience in description, the number of the virtual cameras 300 is one. In at least one embodiment this disclosure is also applicable to a case in which the number of the virtual cameras is two.

Now, a description is given of the virtual camera 300, the hand object 400 (example of the operation object), the tablet object 500 (example of the second object), and the monitor object 600 (example of the first object) that are included in the virtual space 200 with reference to FIG. 9. In FIG. 9, the virtual space 200 includes the virtual camera 300, the hand object 400, the monitor object 600, and the tablet object 500. The control unit 121 generates the virtual space data for defining the virtual space 200 including those objects. As described above, the virtual camera 300 is synchronized with the movement of the HMD 110 worn by the user U. That is, the visual field of the virtual camera 300 is updated based on the movement of the HMD 110.

The hand object 400 is a term for collectively referring to the left hand object and/or the right hand object. As described above, the left hand object is moved in accordance with the movement of the controller 320L worn on the left hand of the user U (see, FIG. 13A). In the same manner, the right hand object is moved in accordance with the movement of the controller 320R worn on the right hand of the user U. In at least one embodiment, for the sake of convenience of description, only one hand object 400 is arranged within the virtual space 200, but two hand objects 400 may be arranged within the virtual space 200.

The control unit 121 acquires the positional information on the controller 320 from the position sensor 130, and then associates the position of the hand object 400 within the virtual space 200 with the position of the controller 320 within the real space based on the acquired positional information. In this manner, the control unit 121 controls the position of the hand object 400 based on the position of the hand of the user U (position of the controller 320).

The user U can operate the respective fingers of the hand object 400 arranged within the virtual space 200 by operating the operation button 302. That is, the control unit 121 acquires the operation signal corresponding to the input operation performed on the operation button 302 from the controller 320, and then controls actions of the hand and fingers of the hand object 400 based on the operation signal. For example, the user U can cause the hand object 400 to hold the tablet object 500 by operating the operation button 302 (see FIG. 9). In at least one embodiment, the hand object 400 and the tablet object 500 are movable in accordance with the movement of the controller 320 while the hand object 400 is holding the tablet object 500. In this manner, the control unit 121 is configured to control the action of the hand object 400 in accordance with the movements of the hand and fingers of the user U.

The monitor object 600 is configured to display a menu (in particular, a menu screen 610). A plurality of selection items to be selected by the user U may be displayed on the menu screen 610. In FIG. 9, “Western food”, “Japanese food”, and “Chinese food” are displayed on the menu screen 610 as the selection items. In addition, stage information, acquired item information, a “retire” button, and/or a game restart button may be displayed on the menu screen 610. The monitor object 600 may be fixedly arranged at a predetermined position within the virtual space 200. The position at which the monitor object 600 is arranged may be changeable through an operation performed by the user. The position at which the monitor object 600 is arranged may also be automatically changed based on a predetermined action rule stored in the memory.

The tablet object 500 can operate the menu displayed on the monitor object 600. The control unit 121 operates the menu displayed on the monitor object 600 based on an input operation performed on the tablet object 500 by the hand object 400. Specifically, the control unit 121 controls the action of the hand object 400 based on the operation signal transmitted from the controller 320 and/or the positional information on the controller 320 transmitted from the position sensor 130. After that, the control unit 121 identifies an interaction between the hand object 400 and the tablet object 500, and then identifies the input operation performed on the tablet object 500 by the hand object 400 based on the interaction. The control unit 121 selects one of the plurality of selection items (“Western food”, “Japanese food”, and “Chinese food”) displayed on the menu screen 610 of the monitor object 600 based on the identified input operation. The control unit 121 executes predetermined processing corresponding to a result of the selection.

The control unit 121 may operate the menu displayed on the monitor object 600 based on not only the input operation performed on the tablet object 500 directly by the hand object 400 but also an input operation performed thereon indirectly. For example, the hand object 400 maybe operated as described above to hold and operate a predetermined agent object within the virtual space 200, and the input operation performed on the tablet object 500 by the hand object 400 may be identified based on an interaction between the agent object and the tablet object 500. The control unit 121 selects one of the plurality of selection items (“Western food”, “Japanese food”, and “Chinese food”) displayed on the menu screen 610 of the monitor object 600 based on the identified input operation. The control unit 121 executes predetermined processing corresponding to a result of the selection. In at least one embodiment, the agent object is an object that implicitly appears to the user to enable the execution of input to the tablet object 500, and is, for example, an object that imitates a touch pen or other such object.

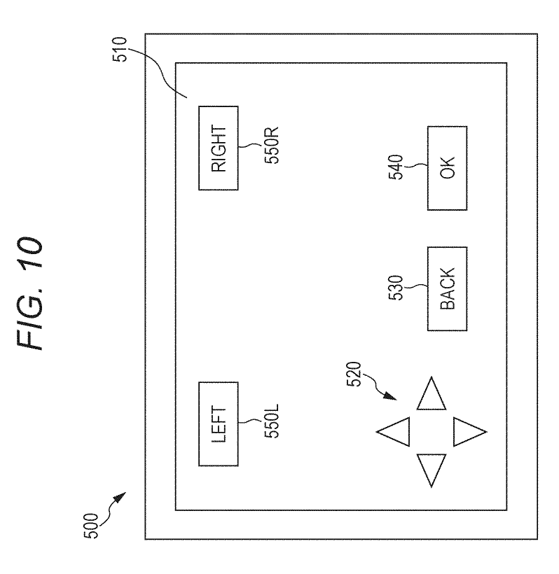

Next, an example of a display screen 510 of the tablet object 500 is described with reference to FIG. 10. A direction key 520, a BACK button 530, an OK button 540, a LEFT button 550L, and a RIGHT button 550R are displayed on the display screen 510. In this case, the direction key 520 is a button for controlling a movement of a cursor displayed on the menu screen 610 of the monitor object 600.

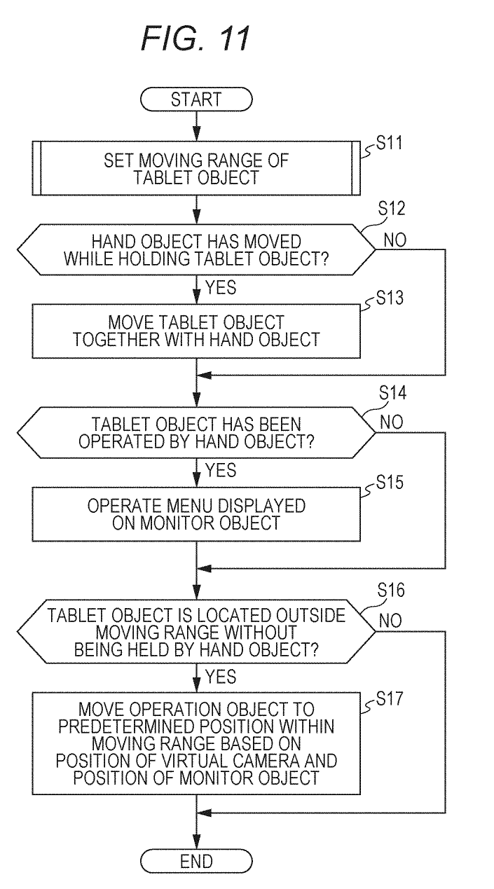

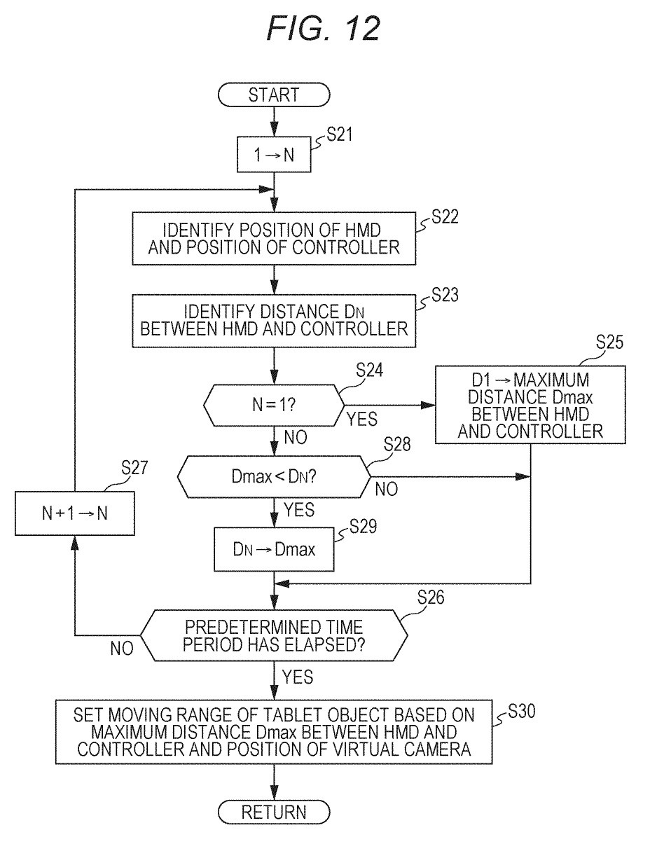

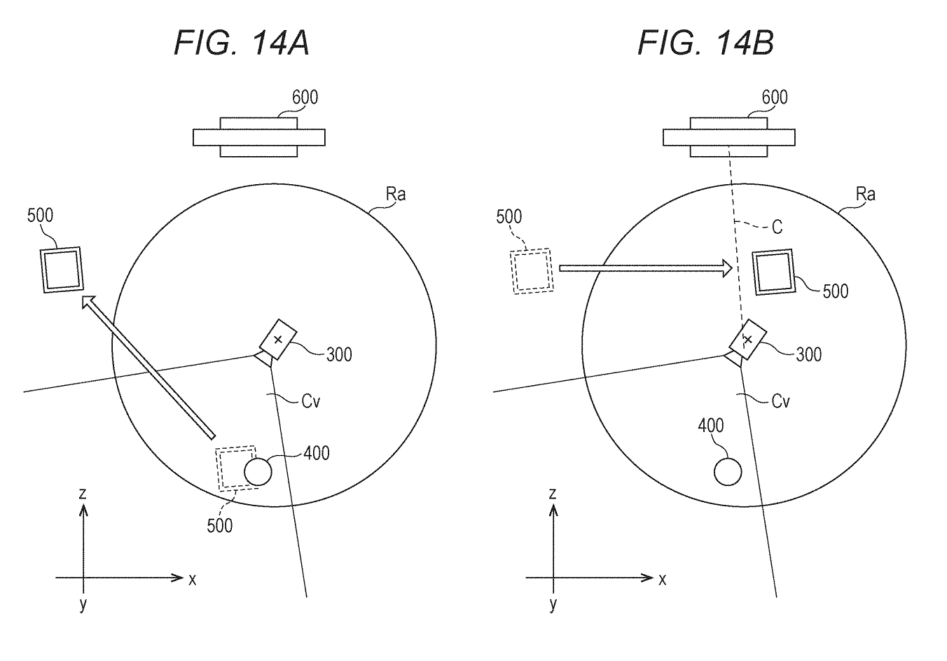

Next, the information processing method according to at least one embodiment is described below with reference to FIG. 11 to FIGS. 14A-14B. FIG. 11 is a flowchart of the information processing method according to at least one embodiment. FIG. 12 is a flowchart of an example of a method for setting a moving range of the tablet object 500 according to at least one embodiment of this disclosure. FIG. 13A is a diagram of a user U immersed in the virtual space 200 according to at least one embodiment of this disclosure. FIG. 13B is a diagram of an example of the moving range (moving range Ra) of the tablet object 500 set around the virtual camera 300 according to at least one embodiment of this disclosure. FIG. 13C is a diagram of an example of the moving range (moving range Rb) of the tablet object 500 set around the virtual camera 300 according to at least one embodiment of this disclosure. FIG. 14A is a diagram of the tablet object 500 positioned outside the moving range Ra according to at least one embodiment of this disclosure. FIG. 14B is a diagram of the tablet object 500 moves from outside the moving range Ra to a predetermined position within the moving range Ra according to at least one embodiment of this disclosure. In the following description, the case of moving the tablet object 500 is described as an example, but the above-mentioned agent object may be moved by the same method in place of the tablet object 500.

In FIG. 11, in Step S11, the control unit 121 sets the moving range of the tablet object 500. In this case, the moving range of the tablet object 500 may be defined as a range that allows the user U to hold the tablet object 500 through use of the hand object 400 while the user U is not moving (namely, while the coordinates of the position of the user U are kept from changing in the real space). When the tablet object 500 is positioned outside the moving range, the control unit 121 moves the tablet object 500 to the predetermined position within the moving range.

In FIG. 13B, the moving range of the tablet object 500 may be the moving range Ra defined as a sphere having a predetermined radius R with a center position of the virtual camera 300 being set as the center. In this case, when a distance between the tablet object 500 and the virtual camera 300 is equal to or smaller than the radius R, the tablet object 500 is determined as existing within the moving range Ra. In contrast, when the distance between the tablet object 500 and the virtual camera 300 is larger than the radius R, the tablet object 500 is determined as existing outside the moving range Ra.

Further, in FIG. 13C, the moving range of the tablet object 500 may be the moving range Rb defined as a spheroid (ellipse) with a center position of the virtual camera 300 being set as the center. In this case, a major axis of the spheroid may be parallel with the w axis of the virtual camera 300, and a minor axis of the spheroid may be parallel with the v axis of the virtual camera 300. The moving range of the tablet object 500 may also be a moving range defined as a cube or a rectangular parallelepiped with the center position of the virtual camera 300 being set as the center.

The following description is based on an example of the moving range of the tablet object 500 is the moving range Ra in FIG. 13B. One of ordinary skill would understand that the description is also applicable to the moving range Rb in FIG. 13C. The radius R of the sphere for defining the moving range Ra is set based on a distance D between the HMD 110 and the controller 320 (controller 320L or controller 320R) in FIG. 13A. An example of a method for setting the moving range Ra (processing executed in Step S11 in FIG. 11) is described with reference to FIG. 12.

In FIG. 12, in Step S21, the control unit 121 sets a value of an integer N to 1. When the processing in FIG. 12 is started, the value of the integer N is first set to 1. For example, the value of the integer N may be incremented by 1 for each frame. For example, when a game moving image has a frame rate of 90 fps, the value of the integer N may be incremented by 1 each time 1/90 second elapses. Subsequently, in Step S22, the control unit 121 identifies the position of the HMD 110 (position of the head of the user U) and the position of the controller 320 (position of the hand of the user U) based on the positional information on the HMD 110 and the positional information on the controller 320 transmitted from the position sensor 130. Subsequently, the control unit 121 identifies a distance DN between the HMD 110 and the controller 320 based on the position of the HMD 110 and the position of the controller 320 that have been identified (Step S23).

Subsequently, because the value of the integer N is 1 (YES in Step S24), the control unit 121 sets an identified distance D1 as a maximum distance Dmax between the HMD 110 and the controller 320 (Step S25). After that, when a predetermined time period has not elapsed (NO in Step S26), in Step S27, the value of the integer N is incremented by 1 (N=2), and the processing returns to Step S22. Subsequently, after the processing of Step S22 is executed, in Step S23, the control unit 121 identifies a distance D2 between the HMD 110 and the controller 320 exhibited when N=2. Subsequently, because N is not equal to 1 (NO in Step S24), the control unit 121 determines whether or not the distance D2 is larger than the maximum distance Dmax (=D1) (Step S28). When determining that the distance D2 is larger than the maximum distance Dmax (YES in Step S28), the control unit 121 sets the distance D2 as the maximum distance Dmax (Step S29). Meanwhile, when determining that the distance D2 is equal to or smaller than the maximum distance Dmax (NO in Step S28), the control unit 121 proceeds to the processing of Step S26. When the predetermined time period has not elapsed (NO in Step S26), in Step S27, the value of the integer N is incremented by 1. In this manner, until the predetermined time period has elapsed, the processing of Steps S22, S23, S28, and S29 is repeatedly executed, and the value of the integer N is incremented by 1 for each frame. That is, until the predetermined time period has elapsed, for each frame, the distance DN between the HMD 110 and the controller 320 is identified, and then the maximum distance Dmax between the HMD 110 and the controller 320 is updated. Subsequently, when determining that the predetermined time period has elapsed (YES in Step S26), the control unit 121 sets the moving range Ra of the tablet object 500 based on the maximum distance Dmax between the HMD 110 and the controller 320 and the position of the virtual camera 300 (Step S30). Specifically, the control unit 121 sets the center position of the virtual camera 300 as the center of the sphere for defining the moving range Ra, and sets the maximum distance Dmax as the radius R of the sphere for defining the moving range Ra. In this manner, the moving range Ra is set based on the maximum value of the distance between the HMD 110 and the controller 320 and the position of the virtual camera 300.

The control unit 121 may set the moving range Ra based on the maximum value of a distance between the virtual camera 300 and the hand object 400 and the position of the virtual camera 300. In this case, in Step S22, the control unit 121 identifies the position of the virtual camera 300 and the position of the hand object 400, and in Step S23, identifies the distance DN between the virtual camera 300 and the hand object 400. In addition, the control unit 121 keeps identifying the maximum distance Dmax between the virtual camera 300 and the hand object 400 until the predetermined time period has elapsed. The control unit 121 sets the center position of the virtual camera 300 as the center of the sphere for defining the moving range Ra, and sets the maximum distance Dmax between the virtual camera 300 and the hand object 400 as the radius R of the sphere.

In at least one embodiment for setting the moving range Ra, the control unit 121 may set the moving range Ra based on the distance between the HMD 110 and the controller 320, which is exhibited when the user U is taking a predetermined posture, and the position of the virtual camera 300. For example, the moving range Ra may be set based on the distance between the HMD 110 and the controller 320, which is exhibited when the user U is stretching both hands forward while standing, and the position of the virtual camera 300.

Returning to FIG. 11, in Step S12, the control unit 121 determines whether or not the hand object 400 has moved while holding the tablet object 500 (see FIGS. 14). When “YES” is determined in Step S12, the control unit 121 moves the hand object 400 and the tablet object 500 together in accordance with the movement of the controller 320 (Step S13). Meanwhile, when “NO” is determined in Step S12, the processing proceeds to Step S14. Subsequently, in Step S14, the control unit 121 determines whether or not the tablet object 500 has been operated by the hand object 400. When “YES” is determined in Step S14, the control unit 121 operates the menu displayed on the monitor object 600 (menu screen 610) based on the input operation performed on the tablet object 500 by the hand object, and then executes predetermined processing corresponding to a result of the operation (Step S15). Meanwhile, when “NO” is determined in Step S14, the processing proceeds to Step S16.

Subsequently, the control unit 121 determines whether or not the tablet object 500 is located outside the moving range Ra without being held by the hand object 400 (Step S16). For example, in FIG. 14A, after the user U throws away the tablet object 500 through use of the hand object 400, the tablet object 500 is positioned outside the moving range Ra. In another case, after the user U moves without holding the tablet object 500 by the hand object 400, the tablet object 500 is positioned outside the moving range Ra. In this case, because the virtual camera 300 is moved after the user U moves, the moving range Ra set around the virtual camera 300 is also moved. In this manner, the tablet object 500 is positioned outside the moving range Ra. When “YES” is determined in Step S16, the control unit 121 moves the tablet object 500 to the predetermined position within the moving range Ra based on the position of the virtual camera 300 and the position of the monitor object 600 (Step S17). For example, in FIG. 14B, the control unit 121 may identify a position offset by a predetermined distance in a y-axis direction from a center position of a line segment C connecting between a center position of the monitor object 600 and the center position of the virtual camera 300, and then arrange the tablet object 500 at the identified position. Instead, it may be determined in Step S16 only whether or not the tablet object 500 exists outside the moving range Ra.

In this manner, according to at least one embodiment, the menu displayed on the monitor object 600 is operated based on the input operation performed on the tablet object 500 by the hand object 400. That is, the user U can perform a predetermined operation on the tablet object 500 within the virtual space 200 through use of the hand object 400 within the virtual space 200, which is synchronized with the movement of the hand of the user U. As a result of the predetermined operation, the menu displayed on the monitor object 600 is operated. In this manner, the menu operation can be executed by the interaction between the objects within the virtual space 200, and hence a situation is avoided in which a widget or other such UI object may be constantly displayed within the visual-field image. Therefore, an information processing method capable of further enhancing a sense of immersion into the virtual space 200 to be felt by the user U is provided.

Further, even when the tablet object 500 is positioned outside the moving range Ra, the tablet object 500 moves to the predetermined position within the moving range Ra. In this manner, the user U is able to easily find the tablet object 500, and to greatly alleviate time and labor for the user U to pick up the tablet object 500. In addition, the position of the tablet object 500 within the moving range Ra is determined based on a positional relationship between the monitor object 600 and the virtual camera 300 (for example, a center point of the line segment C), which allows the user U to easily find the tablet object 500.

Further, the moving range Ra of the tablet object 500 is determined based on the maximum distance Dmax between the HMD 110 (head of the user U) and the controller 320 (hand of the user U). In this manner, the tablet object 500 is arranged within a range that allows the user U to pick up the tablet object 500 while standing still (while the coordinates of the position of the user are kept from changing in the real space), which can greatly alleviate the time and labor for the user U to pick up the tablet object 500.

Further, in order to implement various types of processing to be executed by the control unit 121 with use of software, an information processing program for executing an information processing method of at least one embodiment on a computer (processor) may be installed in advance into the storage unit 123 or the ROM. Alternatively, the information processing program may be stored in a computer-readable storage medium, for example, a magnetic disk (HDD or floppy disk), an optical disc (for example, CD-ROM, DVD-ROM, or Blu-ray (R) disc), a magneto-optical disk (for example, MO), and a flash memory (for example, SD card, USB memory, or SSD). In this case, the storage medium is connected to the control device 120, and thus the information processing program stored in the storage medium is installed into the storage unit 123. Then, the information processing program installed in the storage unit 123 is loaded onto the RAM, and the processor executes the loaded program. In this manner, the control unit 121 executes the information processing method of at least one embodiment.

Further, the information processing program may be downloaded from a computer on the communication network 3 via the communication interface 125. Also in this case, the downloaded program is similarly installed into the storage unit 123.

This concludes the description of at least one embodiment of this disclosure. However, the description of the at least one embodiment is not to be read as a restrictive interpretation of the technical scope of this disclosure. The at least one embodiment is merely given as an example, and it is to be understood by a person skilled in the art that various modifications can be made to the embodiment within the scope of this disclosure set forth in the appended claims. Thus, the technical scope of this disclosure is to be defined based on the scope of this disclosure set forth in the appended claims and an equivalent scope thereof.

In at least one embodiment, the movement of the hand object is controlled based on the movement of the external controller 320 representing the movement of the hand of the user U, but the movement of the hand object in the virtual space may be controlled based on the movement amount of the hand of the user U. For example, instead of using the external controller, a glove-type device or a ring-type device to be worn on the hand or fingers of the user may be used. With this, the position sensor 130 can detect the position and the movement amount of the hand of the user U, and can detect the movement and the state of the hand and fingers of the user U. Further, the position sensor 130 may be a camera configured to take an image of the hand (including the fingers) of the user U. In this case, by taking an image of the hand of the user with use of a camera, the position and the movement amount of the hand of the user U can be detected, and the movement and the state of the hand and fingers of the user U can be detected based on data of the image in which the hand of the user is displayed, without requiring the user to wear any kind of device directly on his or her hand or fingers.

Further, in at least one embodiment, a tablet object is operated by the hand object based on the position and/or the movement of the hand being a part of the body other than the head of the user U, but, for example, the tablet object may be operated by the foot object (example of the operation object) synchronized with the movement of the foot of the user U based on the position and/or the movement of the foot being a part of the body other than the head of the user U. In this manner, the foot object may be defined as the operation object in place of the hand object.

Further, a remote control object or the like may be defined as an object capable of controlling the menu displayed on a monitor object in place of the tablet object.

1-11. (canceled)

12. An information processing method comprising:
generating virtual space data for defining a virtual space that includes: a first object for displaying a menu; a second object capable of operating the menu; and an operation object;
detecting a movement of a head-mounted device and a movement of a part of a body other than a head of a user;
displaying a visual-field image based on the virtual space data corresponding to the detected movement of the head-mounted device on a display unit of the head-mounted device;
causing the operation object to act in accordance with the detected movement of the part of the body of the user; and
operating the menu based on an input operation performed on the second object by the operation object.

13. The information processing method according to claim 12, further comprising identifying the input operation based on an interaction between the second object and the operation object.

14. The information processing method according to claim 12,
wherein the virtual space data further includes an agent object operable based on an action of the operation object, and
wherein the information processing method further comprises identifying the input operation based on an interaction between the second object and the agent object.

15. The information processing method according claim 12,
wherein the virtual space data further includes an agent object and a virtual camera for defining the visual-field image in accordance with the detected movement of the head-mounted device, and
wherein the information processing method further comprises:
setting a moving range of the second object or the agent object based on a position of the virtual camera within the virtual space;
determining whether or not the second object or the agent object is positioned within the moving range; and
moving, in response to a determination that the second object or the agent object is not positioned within the moving range, the second object or the agent object to a predetermined position within the moving range.

16. The information processing method according to claim 15, further comprising moving the second object or the agent object to the predetermined position within the moving range based on the position of the virtual camera and a position of the first object.

17. The information processing method according to claim 15, further comprising:
measuring a distance between the head-mounted device and a controller on the part of the body; and
setting the moving range based on the measured distance and the position of the virtual camera.

18. The information processing method according to claim 15, further comprising:
identifying a maximum value of a distance between the virtual camera and the second object based on a position of the head-mounted device and a controller on the part of the body; and
setting the moving range based on the identified maximum value of the distance and the position of the virtual camera.

19. The information processing method according to claim 15, further comprising:
identifying a maximum value of a distance between the virtual camera and the second object based on the position of the virtual camera and a position of the operation object; and
setting the moving range based on the identified maximum value of the distance and the position of the virtual camera.

20. A system comprising:
a head-mounted display;
a non-transitory computer readable medium configured to store instructions; and
a processor connected to the non-transitory computer readable medium, wherein the processor is configured to execute the stored instructions for:
generating virtual space data for defining a virtual space that includes: a first object for displaying a menu; a second object capable of operating the menu; and an operation object;
detecting a movement of a head-mounted display and a movement of a part of a body other than a head of a user;
instructing the head-mounted display to display a visual-field image based on the virtual space data corresponding to the detected movement of the head-mounted display;
causing the operation object to act in accordance with the detected movement of the part of the body of the user; and
operating the menu based on an input operation performed on the second object by the operation object.

21. The system according to claim 20, wherein the processor is further configured to execute the stored instructions for identifying the input operation based on an interaction between the second object and the operation object.

22. The system according to claim 20,
wherein the virtual space data further includes an agent object operable based on an action of the operation object, and
the processor is further configured to execute the stored instructions for identifying the input operation based on an interaction between the second object and the agent object.

23. The system according claim 20,
wherein the virtual space data further includes an agent object and a virtual camera for defining the visual-field image in accordance with the detected movement of the head-mounted device, and
the processor is further configured to execute the stored instructions for:
setting a moving range of the second object or the agent object based on a position of the virtual camera within the virtual space;
determining whether or not the second object or the agent object is positioned within the moving range; and
moving, in response to a determination that the second object or the agent object is not positioned within the moving range, the second object or the agent object to a predetermined position within the moving range.

24. The system according to claim 23, wherein the processor is further configured to execute the instructions for moving the second object or the agent object to the predetermined position within the moving range based on the position of the virtual camera and a position of the first object.

25. The system according to claim 23, further comprising a controller for attaching to the part of the body of the user, wherein the processor is further configured to execute the instructions for:
measuring a distance between the head-mounted device and the controller; and
setting the moving range based on the measured distance and the position of the virtual camera.

26. The system according to claim 23, further comprising a controller for attaching to the part of the body of the user, wherein the processor is further configured to execute the instructions for:
identifying a maximum value of a distance between the virtual camera and the second object based on a position of the head-mounted device and the controller; and
setting the moving range based on the identified maximum value of the distance and the position of the virtual camera.

27. The system according to claim 23, wherein the processor is further configured to execute the stored instructions for:
identifying a maximum value of a distance between the virtual camera and the second object based on the position of the virtual camera and a position of the operation object; and
setting the moving range based on the identified maximum value of the distance and the position of the virtual camera.

28. An information processing device comprising:
a processor; and
a memory connected to the processor,
wherein the processor is configured to control the information processing device for:
generating virtual space data for defining a virtual space that includes: a first object for displaying a menu; a second object capable of operating the menu; and an operation object;
detecting a movement of a head-mounted device and a movement of a part of a body other than a head of a user;
displaying a visual-field image based on the virtual space data corresponding to the detected movement of the head-mounted device on a display unit of the head-mounted device;
causing the operation object to act in accordance with the detected movement of the part of the body of the user; and
operating the menu based on an input operation performed on the second object by the operation object.
